(19) United States
(12) Patent Application Publication
(10) Pub. No.: US 2005/0199125 A1
(43) Pub. Date: Sep. 15, 2005

(54) Air transporter and/or conditioner device with features for cleaning emitter electrodes

(75) Inventors: Charles E. Taylor, Punta Gorda, FL (US); Andrew J. Parker, Novato, CA (US)

Correspondence Address: FLIESLER MEYER, LLP, FOUR EMBARCADERO CENTER, SUITE 400, SAN FRANCISCO, CA, 94111, US

(73) Assignee: Sharper Image Corporation, Novato, CA (US)

(21) Appl. No.: 11/062,173

(22) Filed: Feb. 18, 2005

Related U.S. Application Data
(60) Provisional application No. 60/545,698, filed on Feb. 18, 2004.
(60) Provisional application No. 60/579,481, filed on Jun. 14, 2004.

(51) Int. Cl. B03C 3/74; B01J 19/08

(52) U.S. Cl. 96/39; 422/186.07; 422/186.04; 96/51; 96/96

(57) ABSTRACT

An air conditioning system, comprising an emitter wire configured in a loop; and a collector electrode positioned downstream from the emitter wire. The emitter wire rotates when the collector electrode is moved vertically in a desired direction. The emitter wire is cleaned when rotated by a device such as a scraper, a rotatable wheel in contact with the wire, a brush, and a cleaning member on the pulley itself.

### CLAIM OF PRIORITY

This Patent Application claims priority under 35 U.S.C. 119(e) of the co-pending U.S. Provisional Patent Application Ser. No. 60/545,698, filed Feb. 18,2004, entitled, “Electro-Kinetic Air Transporter And/Or Conditioner Devices With Features For Cleaning Emitter Electrodes,” (Attorney Docket No. SHPR-01430US0) and U.S. Provisional Patent Application Ser. No. 60/579,481, filed Jun. 14,2004, entitled, “Air Transporter And/Or Conditioner Devices With Features For Cleaning Emitter Electrodes” (Attorney Docket No. SHPR-01430US2), both of which are hereby incorporated herein by reference.

### RELATED APPLICATIONS

The present invention is related to the following patent applications and patents, each of which is incorporated herein by reference:

U.S. patent application Ser. No. 10/074,347, filed Feb. 12,2002, and entitled “Electro-Kinetic Air Transporter-Conditioner Device with Enhanced Housing” (Attorney Docket No. SHPR-01028US5);

U.S. Pat. No. 6,176,977, issued Jan. 23, 2001, entitled “Electro-Kinetic Air Transporter-Conditioner” (Attorney Docket No. SHPR-01041US0);

U.S. Pat. No. 6,350,417 issued May 4, 2000, entitled “Electrode Self Cleaning Mechanism For Electro-kinetic Air Transporter-Conditioner” (Attorney Docket No. SHPR-01041US1);

U.S. patent application Ser. No. 10/074,207, filed Feb. 12, 2002, entitled “Electro-Kinetic Air Transporter-Conditioner Devices With Interstitial Electrode” (Attorney Docket No. SHPR-01041USN);

U.S. Pat. No. 6,749,667, issued Jun. 15, 2004, entitled “Electrode Self-Cleaning Mechanism For Electro-Kinetic Air Transporter-Conditioner Devices” (Attorney Docket No. SHPR-01041UST);

U.S. patent application Ser. No. 60/590,688, filed Jul. 23,2004, entitled “Air Conditioner Device With Removable Driver Electrodes” (Attorney Docket No. SHPR-01361USA);

U.S. patent application Ser. No. 10/625,401, filed Jul. 23,20043, entitled “Electro-Kinetic Air Transporter And Conditioner Devices With Enhanced Arcing Detection And Suppression Features” (Attorney Docket No. SHPR-01361USB);

U.S. patent application Ser. No. 60/590,735, filed Jul. 23,2003, entitled “Air Conditioner Device With Variable Voltage Controlled Trailing Electrodes” (Attorney Docket No. SHPR-01361USG);

U.S. patent application Ser. No. 60/590,960, filed Jul. 23,2003, entitled “Air Conditioner Device With Individually Removable Driver Electrodes” (Attorney Docket No. SHPR-01361USQ);

U.S. patent application Ser. No. 60/590,445, filed Jul. 23, 2003 entitled “Air Conditioner Device With Enhanced Germicidal Lamp” (Attorney Docket No. SHPR-01361USR);

U.S. patent application Ser. No. 11/004,397, filed Dec. 3,2004, entitled “Enhanced Germicidal Lamp” (Attorney Docket No. SHPR-01361USY);

U.S. patent application Ser. No. 10/717,420, filed Nov. 19,2003, entitled “Electro-Kinetic Air Transporter And Conditioner Devices With Insulated Driver Electrodes” (Attorney Docket No. SHPR-01414US1);

U.S. patent application Ser. No. 11/007,734 filed Dec. 3, 2004, entitled “Electro-Kinetic Air Transporter and Conditioner Devices with Insulated Driver Electrodes” (Attorney Docket No. SHPR-01414US3);

U.S. patent application Ser. No. 11/006,344, filed Dec. 7, 2004, entitled “Air Conditioner Device With 3/2 Configuration And Individually Removable Driver Electrodes” (Attorney Docket No. SHPR-01414US4);

U.S. patent application Ser. No. 11/007,395, filed Dec. 3, 2004, entitled “Air Conditioner Device With Removable Driver Electrodes” (Attorney Docket No. SHPR-01414US5);

U.S. patent application Ser. No. 11,007,556, filed Dec. 3, 2004, entitled “Air Conditioner Device With Removable Driver Electrodes” (Attorney Docket No. SHPR-01414US6);

U.S. patent application Ser. No. ______ , filed Dec. 3, 2004, entitled “Air Conditioner Device With Removable Driver Electrodes” (Attorney Docket No. SHPR-01414US7);

U.S. patent application Ser. No. 11/003,671 filed Dec. 3,2004, entitled “Air Conditioner Device With Variable Voltage Controlled Trailing Electrodes” (Attorney Docket No. SHPR-01414US8);

U.S. patent application Ser. No. 11/006,344, filed Dec. 3, 2004, entitled “Air Conditioner Device With Individually Removable Driver Electrodes” (Attorney Docket No. SHPR-01414US9);

U.S. patent application Ser. No. 11/003,032, filed Dec. 3, 2004, entitled “Air Conditioner Device With Enhanced Germicidal Lamp” (Attorney Docket No. SHPR-01414USA);

U.S. patent application Ser. No. 11/003,516, filed Dec. 3, 2004, entitled “Air Conditioner Device With Removable Driver Electrodes” (Attorney Docket No. SHPR-01414USB);

U.S. patent application Ser. No. ______ filed Jan. 25,2005, entitled “Electrostatic Precipitator With Insulated Driver Electrodes” (Attorney Docket No. SHPR-01421US0);

U.S. patent application Ser. No. ______ filed ______ ,entitled “Air Conditioner Device With Ozone-Reducing Agent Associated With An Electrode Assembly” (Attorney Docket No. SHPR-01421US1);

U.S. patent application Ser. No. ______ filed ______ ,entitled “Air Conditioner Device With A Temperature Conditioning Device Having A Rechargeable Thermal Storage Mass” (Attorney Docket No. SHPR-01421US2);

U.S. patent application Ser. No. ______ filed ______ ,entitled “Air Conditioner Device With A Temperature Conditioning Device Having A Thermoelectric Heat Exchanger” (Attorney Docket No. SHPR-01421US3);

U.S. patent application Ser. No. 10/774,759 filed Feb. 9,2004, entitled “Electrostatic Precipitators With Insulated Driver Electrodes” (Attorney Docket No. SHPR-01436US0); and

U.S. patent application Ser. No. filed Jan. 25,2005, entitled “Air Conditioner Device With Partially Insulated Collector Electrode” (Attorney Docket No. SHPR-01485US0).

### FIELD OF THE INVENTION

The present invention relates generally to devices that electrically transport and/or condition air. More specifically, the present invention relates to a system and method of automatically cleaning such devices.

### BACKGROUND OF THE INVENTION

It is known in the art how to produce an airflow using electro-kinetic techniques, by which electrical power is converted into a flow of air without mechanically moving components. Such systems were described, for example, in U.S. Pat. No. 4,789,801 to Lee (1988), as well as in U.S. Pat. No. 6,176,977 to Taylor et al. (2001), both of which are hereby incorporated by reference. As is described in these patents, an electro-kinetic air transporter and conditioner system typically includes a first set of emitter electrodes and second set of collector electrodes, with each electrode set including one or more electrodes. While the collector electrodes are typically in need of cleaning more often than the emitter electrodes, the emitter electrodes can eventually accumulate a deposited layer or coating of fine ash-like material. It would be useful to provide a mechanism for cleaning the emitter electrodes.

### BRIEF DESCRIPTION OF THE FIGURES

FIG. 1 illustrates a perspective view of an exemplary electro-kinetic conditioner system.

FIG. 2 illustrates a perspective view of a wire loop emitter electrode cleaning system in accordance with one embodiment of the present invention.

FIG. 3 illustrates a cross-sectional view of the cleaning system along line 3-3 in FIG. 2 in accordance with another embodiment of the present invention.

FIGS. 4 illustrates a top view of another emitter electrode cleaning assembly in accordance with one embodiment of the present invention.

FIG. 5 illustrates a perspective view of a wire loop emitter electrode cleaning system in accordance with one embodiment of the present invention.

FIGS. 6-8 illustrate various mechanisms for removing debris from the wire loop emitter electrodes in accordance with embodiments of the present invention.

FIG. 9 is a block diagram of an exemplary circuit used to drive and control an electro-kinetic conditioner system, according to embodiments of the present invention.

### DETAILED DESCRIPTION OF THE PRESENT INVENTION

The purpose of emitter electrodes (e.g., wire-shaped electrodes), of electro-kinetic air transporter and conditioner systems, is to produce a corona discharge that ionizes (i.e., charges) the particles in the air in the vicinity of the emitter electrodes. Collector electrodes, which typically have an opposite charge as the emitter electrodes, will attract the charged particles to cause the charged particles to collect on the collector electrodes, thereby cleaning the air. The collector electrodes preferably can be removed vertically from a housing (containing the electrodes), manually cleaned, and then returned to the housing. Although the collector electrodes are typically in need of cleaning more often then the emitter electrodes, the emitter electrodes can eventually accumulate a deposited layer or coating of fine ash-like material. Additionally, dendrites present in the air may accumulate on the emitter electrodes. If such deposits (also referred to hereafter as debris) are allowed to accumulate, the efficiency of the system may eventually be degraded. Further, such deposits (i.e., debris) may also cause the device to produce an audible oscillation.

There are various schemes for cleaning the emitter electrodes. In one embodiment, a sheet or strip of electrically insulating material extends from abase that is associated with the collector electrodes. When the collector electrodes are vertically removed from a top of the housing (and when also returned to the housing), the insulating material scrapes against the emitter electrodes, thereby frictionally cleaning the emitter electrodes. In another embodiment, beads or bead-like mechanisms can be used to clean the emitter electrodes. In particular, the beads have a channel through which the wire-like emitter electrodes extend. By rotating the housing upside down, gravity causes the beads to slide along the emitter electrodes to frictionally clean the emitter electrodes. Additional details are provided in the '417 patent and the '193 application, both of which are incorporated by reference.

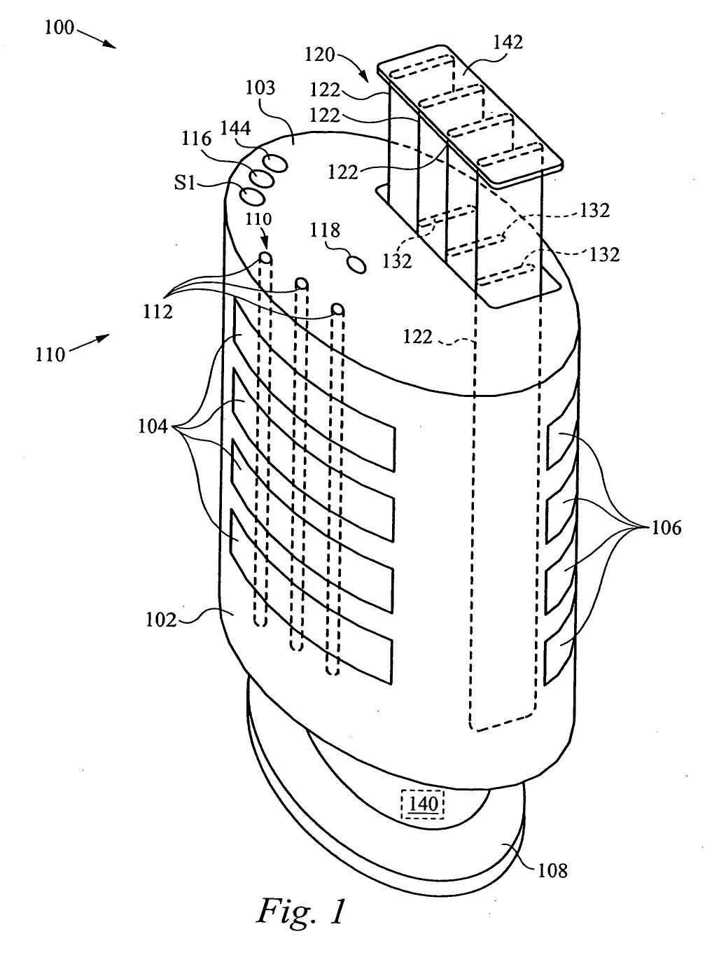

FIG. 1 illustrates, schematically, an exemplary electro-kinetic conditioner system 100 in accordance with one embodiment of the present invention. The system includes a first set 110 of emitter electrodes 112 and a second set 120 of collector electrodes 122 located within a housing 102. While each set is shown as including multiple electrodes, a set alternatively includes as few as one electrode. In this embodiment, the emitter electrodes 112 are preferably connected to a positive terminal of a high voltage generator 140, and the collector electrodes 112 are preferably connected to a negative terminal of the high voltage generator 140. It is noted that embodiments of the present invention may also relate to electrode arrangements that include driver electrodes 132 which can also be removable from the housing 102. The exemplary housing 102 includes intake vents 104, outlet vents 106, and a base pedestal 108. Preferably, the housing 102 is free standing and/or upstandingly vertical and/or elongated. The vents 104 and 106 may be separate or combined into one unit. These vents 104, 106 ensure that adequate flow of ambient air is drawn into the housing 102 as well as made available to the electrodes, and that adequate flow of ionized cleaned air moves out from housing 102.

The present system is preferably powered by an AC-DC power supply that is energizable or excitable using switch S1. Switch S1, along with the other user- operated switches such as a control dial 144, are preferably located on or near a top 103 of the housing 102. Additionally, a boost button 116, as well as one or more indicator lights 118, are alternatively located on the housing 102. The whole system is self-contained in that other than ambient air, nothing is required from beyond the housing 102, except perhaps an external operating voltage, for operation.

A user-liftable handle member 142 is shown affixed to the collector electrodes 122, which normally rest within the housing 102. The housing 102 also encloses the emitter electrodes 112 and, in one embodiment, the driver electrodes 132. In one embodiment, the collector electrodes 122 and/or the driver electrodes 132 are removable out of the housing 102 while the emitter electrodes 112 preferably remain within the housing 102. As is evident from FIG. 1, the collector electrodes 122 are able to be lifted vertically out from an aperture in the top 103 of the housing 102 along the longitudinal axis or direction of the elongated housing 102. This arrangement also allows for a user to return the collector electrodes 122, with the assistance of gravity, back to their resting position within the housing 102. It should be noted that the collector electrodes 122 are alternatively removable and insertable with respect to the housing in a horizontal instead of vertical direction.

During operation of the device 100, the high voltage generator 140 produces a high voltage potential difference between the emitter electrodes 112 and the collector electrodes 122. For example, the voltage to the emitter electrodes 112 is +6 KV, while the voltage to the collector electrodes 122 is −10 KV, thereby resulting in a 16 KV potential difference between the emitter electrodes 112 and collector electrodes 122. This potential difference produces a high intensity electric field that is highly concentrated around the emitter electrodes 112. Other voltage arrangements are also likely, as explained in the Ser. No. 10/717,420 application, which is incorporated by reference. More specifically, a corona discharge takes place from the emitter electrodes 112 to the collector electrodes 122 thereby producing charged ions. Particles (e.g., dust particles) in the vicinity of the emitter electrodes 112 are charged by the ions. The charged ions are repelled by the emitter electrodes 112 and are attracted to and collected by the collector electrodes 122.

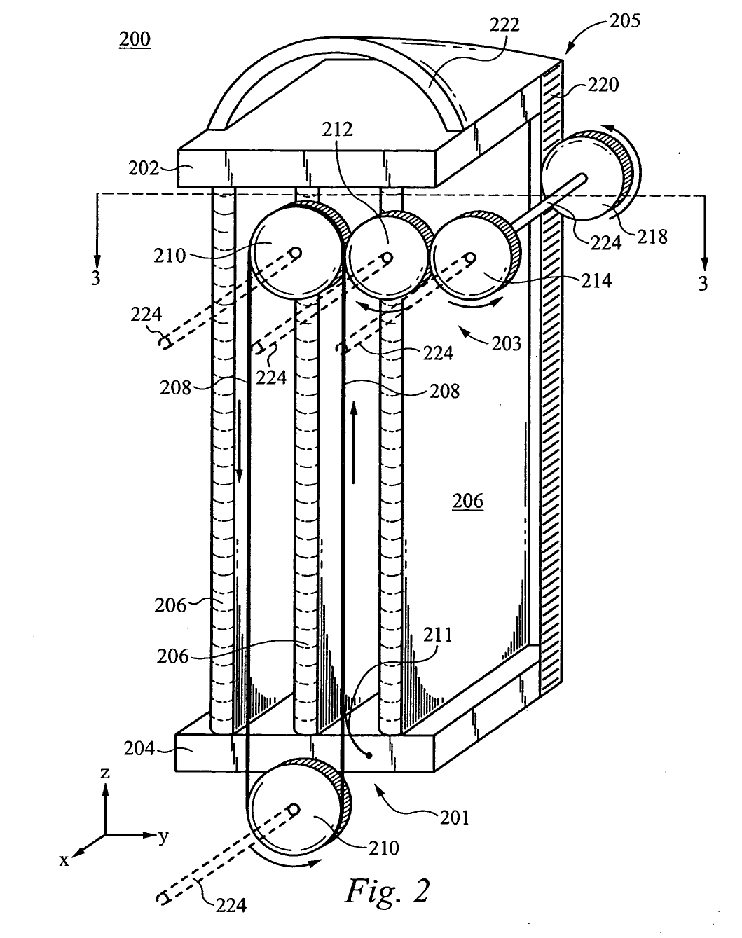

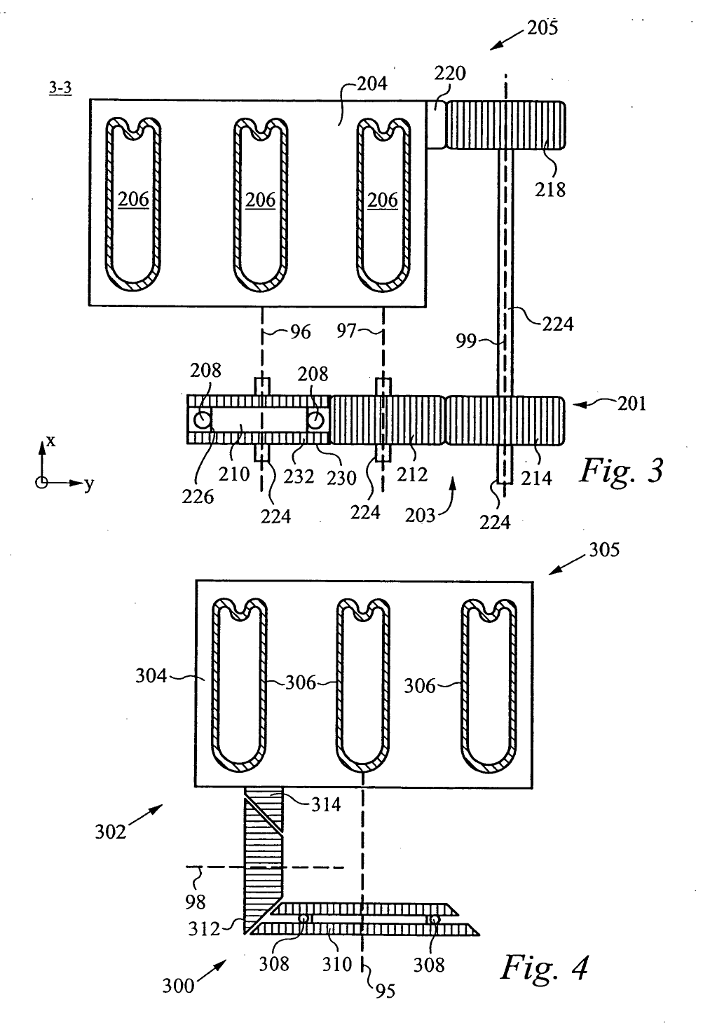

FIGS. 2 and 3 illustrate different views of one embodiment 200 of the present invention. As shown in FIG. 2, the emitter electrode is preferably a conductive emitter electrode wire 208 preferably disposed around at least two opposed rotatable wheels or pulleys 210 in a loop 201 along which the wire 208 is moved when the pulleys 210 are rotated. Although pulleys 210 are described herein, it is apparent to one skilled in the art that any other appropriate mechanism is alternatively used to instead of the pulleys to move the emitter electrode wires 208 about the loop 201. For brevity, the emitter electrode wire loop 201 is referred to hereinafter as the loop 201.

The loop 201 preferably forms two individual emitter wires 208 which are upstream of the leading edges of the collector electrodes 206. In another embodiment, the loop 201 is positioned such that the emitter wires 208 are located downstream of the leading edges of the collector electrodes 206. It should be noted that although only one loop 201 is shown in FIG. 2, any number of loops 201 are contemplated with the present invention. In one embodiment, the diameter of each pulley 210 is equal to the distance between two collector electrodes 206 although not necessarily. The loop 201 is preferably positioned such that the emitter wires 208 are upstream and between the adjacent collector electrodes 206. In another embodiment, the loop 201 is positioned such that the emitter wires 208 are directly upstream of the leading edges of the collector electrodes 206.

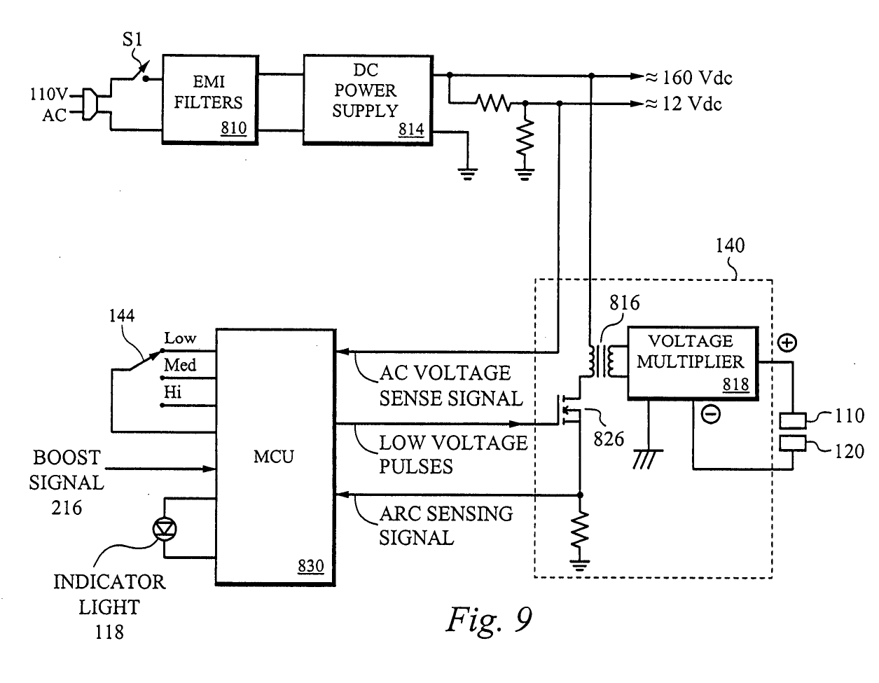

The emitter electrode wire 208 is preferably electrically connected to a positive terminal of the voltage source 140 (FIG. 9). In another embodiment, a conductive contact spring 211, as shown in FIG. 2, is connected to the voltage source 140, whereby the contact 211 touches the emitter electrode 208 to operate the electrode 208. Electrically, the voltage source 140 will impart a desired voltage potential to the emitter electrode wire 208, whereby each individual wire 208 simultaneously acts as an ion emitting surface when charged.

As shown in FIG. 2, the system 200 preferably includes a gear assembly 203 which includes the pulleys 210, an intermediate gear 212 and a set of gears 214, 218. The gears 214, 218 are preferably coupled to one another by a shaft 224 as shown in FIGS. 2 and 3. Although not shown, the shaft 224 or any other securing device secures the gears 214, 218 within the housing 102 such that the gears 214, 218 are held in place and are able to freely rotate. As shown in FIG. 2, the gear 214 meshes with the intermediate gear 212 and drives the intermediate gear 212 to rotate about the shaft 224, as shown by the arrows. The intermediate gear 212 is meshed with one or more pulleys 210, whereby rotation of the intermediate gear 212 causes the top pulley 210 to rotate about the shaft 224, as shown by the arrows. It should be noted that although the intermediate gear 212 is used in the embodiment, the intermediate gear 212 is alternatively not required. Although the intermediate gear 212 is shown coupled to the top pulley 210 in FIG. 2, it is contemplated that the intermediate gear 212 is alternatively, or additionally, coupled to the bottom pulley 210 or another pulley (not shown) positioned between the top and bottom pulleys 210. In one embodiment, all of the gears in the gear system 203 are of the same diameter and have the same gear dimensions. In another embodiment, at least one gear has a different diameter and/or gear dimension. Therefore, any number or variations of gear ratios are contemplated in the present emitter cleaning system.

As shown in FIG. 3, each of the pulleys 210 preferably has an inner peripheral surface 226 and an outer peripheral surface 230. In one embodiment, the emitter electrode wire 208 is disposed around the inner peripheral surface 206 of the pulleys. In the present invention, the outer peripheral surface 230 includes gear teeth 232 which are designed to mesh with another gear, preferably the intermediate gear 212, to rotate the pulleys 210.

As shown in FIG. 2, the system 200 includes a collector electrode assembly 205 which has a set of collector electrodes 206 attached between two opposing electrode mounting brackets 202, 204. The collector electrode assembly 205 preferably includes a handle 222 which is attached to the top mounting bracket 202. In the embodiment shown in FIG. 2, the collector electrode assembly 205 preferably includes a drive rack 220 between the top and bottom mounting brackets 202, 204 which interacts with the gear 218 of the gear assembly 203. Although the drive rack 220 is shown spanning the side of te assembly from the top to the bottom mounting bracket, the rack 220 is alternatively only disposed on the top and/or bottom mounting bracket 202, 204.

As previously discussed, the collector electrodes 206 are removable from the housing 102 (FIG. 1) by vertically pulling the handle 222 away from the top surface 103 of the housing 102 (FIG. 1). Further, the collector electrodes 206 are able to be vertically inserted into the device 100 by inserting the mounting brackets 202, 204 through the aperture in the top surface 103 of the device 100. The gear 218 of the gear assembly 203 is configured to mesh with the drive rack 220 of the collector electrode assembly 205. Generally, in one embodiment, removal and/or insertion of the collector electrodes 206, with respect to the housing, causes the drive rack 220 to rotate the gears 214 and 218 about the shaft 224. As the gear 218 rotates about the shaft 224, gear 214 causes the intermediate gear 212 to rotate the pulleys 210, and thereby move the emitter electrode wire 208 along the loop 201. The gear 218 can be a one-way pawl gear, whereby only removal or insertion of the collector electrode assembly 205 in the vertical direction will rotate the gear 218. It should be noted that the collector electrode assembly 205 is alternatively removable and insertable in a horizontal, instead of vertical, direction, whereby the lateral motion of the collector electrode assembly 205 causes the emitter electrode wire 208 to rotate.

The operation for cleaning the emitter electrode wire 208 will now be discussed. In one example, the user removes the collector electrode assembly 205 from the housing, whereby the vertical movement of the assembly 205 does not operate the gear assembly 203 due to the one-way pawl gear 218. In the example, as the collector electrode assembly 205 is inserted into the housing, the drive rack 220 catches and meshes with the gear 218. The downward movement of the collector assembly 205 and drive rack 220 in the vertical direction, as shown by the arrows, causes the meshed gear 218 as well as gear 214 to rotate about the shaft 224 in a counterclockwise direction. Since the gear 214 in the example is meshed with the intermediate gear 212, the counter-clockwise rotation of the gear 214 causes the intermediate gear 212 to rotate about its shaft 224 in the clockwise direction, as shown by the arrows. In addition, since the intermediate gear 212 is meshed with the top pulley 210 in the example, the clockwise rotation of the intermediate gear 212 causes the pulley 210 to rotate about its shaft 224 in the counter-clockwise direction, as shown by the arrows in FIG. 2. The rotation of the pulleys 210 thereby causes the emitter electrode wire 208 to move along the loop 201, as shown by the arrows in FIG. 2. The movement of the wire 208 along the loop 201 in effect cleans the emitter wire 208, as will discussed in more detail below. Of course, the system can be configured such that the emitter wire is moved along the loop 201 when the collector assembly 205 is alternatively or additionally lifted upward out of the housing 102.

FIG. 4 illustrates a schematic of another embodiment of the emitter electrode cleaning assembly 302 in accordance with the present invention. In the embodiment in FIG. 4, the collector electrode assembly 305 includes a drive rack 314 located on the bottom mounting bracket 304 which faces the emitter electrode loop 300. Alternatively, additionally, the drive rack 314 is located on the top mounting bracket of the collector electrode assembly 305.

In the embodiment shown in FIG. 4, the drive rack 314 is configured to mesh with a beveled intermediate gear 312 between the collector electrode assembly 305 and a set of pulleys 310 upon which the emitter electrode wire 308 is disposed. The beveled intermediate gear 312 is configured to rotate about the axis 98 and the beveled pulley 310 is configured to rotate about the axis 95, whereby the axes 95 and 98 are substantially perpendicular to one another. Alternatively, the axes 95 and 98 are positioned at any other angle with respect to one another. In operation, as the collector electrode assembly 305 is removed and/or inserted into the housing of the device, the vertical movement of the drive rack 314 will cause the intermediate gear 312 to rotate about axis 98. As the intermediate gear 312 rotates, it causes the pulleys 310 to rotate about axis 95, thereby causing the emitter electrode wire 308 to move around the loop 300. As discussed above, the system 302 is configured such that the gears move only when the collector electrode assembly 305 is moved in one vertical direction. Alternatively, moving the collector electrode 205 in both vertical directions causes the electrode emitter wire 308 to move around the loop 300. It is also contemplated that the system can be configured to move the emitter wire 308 along the loop 301 when only the driver electrodes are removed from the housing.

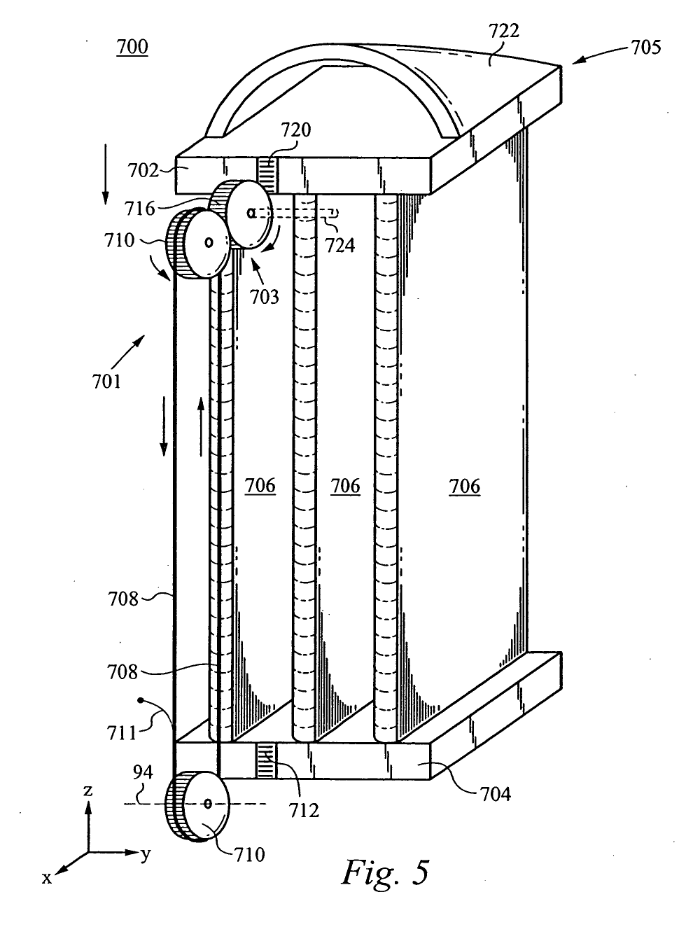

FIG. 5 illustrates a perspective view of the emitter electrode cleaning assembly 700 in accordance with one embodiment of the present invention. In the embodiment shown in FIG. 5, the assembly 700 includes the emitter electrode loop 701, an intermediate gear 716 which is configured to mesh with the top pulley 710 and one or both drive racks 712, 720 located on the top and bottom mounting brackets 702, 704 which mesh with the gear 716.

Unlike the emitter electrode wires in the embodiment shown in FIG. 2, the emitter electrode wires 708 in FIG. 5 are positioned such that one side of the wire loop 708 is downstream of the other side of the wire loop 701. The emitter electrode loop 701 shown in FIG. 5 is positioned such that the wires 708 are located upstream and between two adjacent collector electrodes 706. Alternatively, the emitter electrode loop 701 shown in FIG. 5 is positioned such that the wires 708 are upstream and directly in-line with the leading edge of a collector electrode 706. In another embodiment, one or both of the emitter electrodes 706 are positioned downstream of the leading edge of the collector electrodes. It should be noted that although only one emitter wire loop 701 is shown in FIG. 5, any number of emitter wire loops 701 are contemplated in the system 700.

As the collector electrode assembly 705 is moved vertically downward, the drive rack 712 first meshes with the intermediate gear 716, whereby the downward movement of the drive rack 712 causes the intermediate gear 716 to rotate clockwise about its shaft 724. The clockwise rotation of the intermediate gear 716 causes the meshed pulley 710 to rotate counter-clockwise about its center, thereby causing the emitter electrode wire 708 to move along the loop 701, as shown by the arrows in FIG. 5. As the collector electrode assembly 705 is moved downward, the bottom drive rack 712 moves past and out of contact with the intermediate gear 716. Accordingly, the intermediate gear 716 and the emitter wire loop 708 will not rotate when the intermediate gear 716 is not in appropriate contact with the drive rack 712. As the collector electrode assembly 705 moves further down into the housing, the top drive rack then meshes with and turns the intermediate gear 716, thereby effectively further rotating the pulleys 710 and moving the wire 708 along the loop 701.

In one embodiment, the upward vertical movement of the collector electrode assembly 705 (i.e. removal of the assembly 705 from the housing) also actuates the intermediate gear 716 and thus rotates the pulleys 710 to move the wire 708 along the loop 701. In another embodiment, the intermediate gear is a one-way gear which is actuated only when the collector electrode assembly 705 moves in one direction. In one embodiment, the collector electrode assembly 705 includes a drive gear on either the top or bottom mounting bracket. In another embodiment, the gears can be configured to rotate the pulleys 710 in the same direction when the collector electrode assembly 705 is inserted and removed from the housing 102. In another embodiment, the collector electrode assembly 705 is removable and insertable in a horizontal, instead of vertical, direction, whereby the lateral motion of the collector electrode assembly 705 causes the gear assembly to actuate to cause emitter electrode wire 708 to move along the loop 701. It is also contemplated that the system can be configured to move the emitter wire 708 along the loop 701 when only the driver electrodes are removed from the housing.

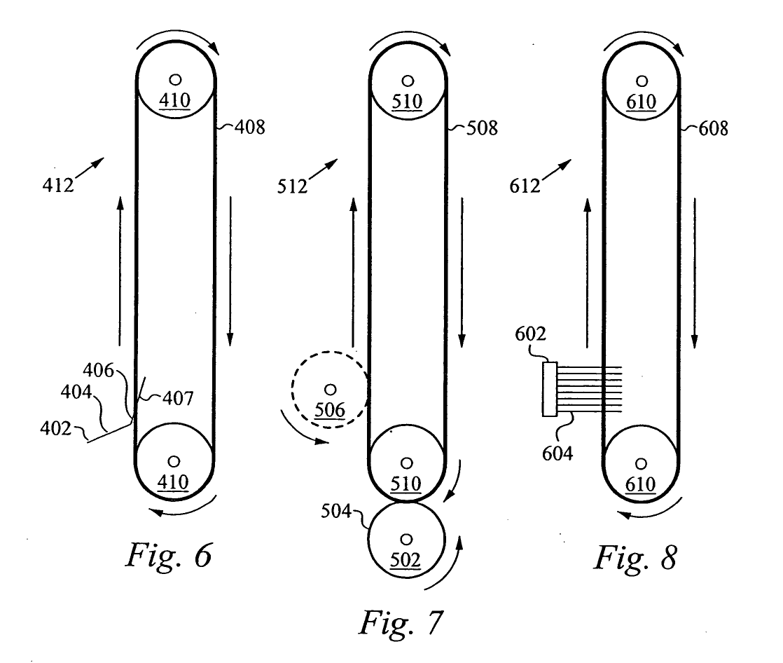

FIGS. 6-8 illustrate various mechanisms for removing debris from the wire loop emitter electrodes in accordance with embodiments of the present invention. Referring to FIG. 6, a pair of pulleys 410 and a single wire emitter electrode 408 in a looped configuration are shown. Also shown is a scraper contact 404 which is used to frictionally clean the emitter electrode wire 408 as the emitter electrode wire 408 is moved along the loop. In one embodiment, the scraper contact 404 is electrically connected to the voltage source 140 (FIG. 9), whereby the scraper contact 404 also energizes the emitter electrode 408.

In accordance with one embodiment of the present invention, the scraper contact 404 is made from a sheet or strip of flexible insulating material, such as those marketed under the trademarks MYLAR and KAPTON. Alternatively, the scraper is made of a non-flexible material. The scraper 404 is preferably made of an insulating material includes a first end 402 prefeably attached to the housing 102 (FIG. 1) and a free end 406 that scrapes against the emitter electrode wire 408 as the wire 408 is rotated. The scraper contact 404 faces the emitter electrode wire 408 and is preferably in a plane perpendicular to the length of the wire 408, although not necessarily. The material of the scraper contact 404 preferably has high voltage breakdown as well as a high dielectric constant, which allows the scraper to withstand high temperature. Alternatively, the scraper contact 404 is conductive and is electrically connected to the voltage source 140. Although not required, a slit 407 is located (e.g. cut) in the free end 406 of the contact 404 such that wire 408 fits into the slit 407 and/or is substantially surrounded by the slit 407. Whenever the pulleys 410 are rotated to move the wire 408, the wire 408 frictionally scrapes against the free end 406 of the scraper contact 404 (or the slit 407 cut therein), causing debris to be removed from the wire 408 and thereby cleaning the wire 408. In embodiments including more than one wire loop emitter electrode 408, a separate scraper contact 404 for each wire electrode 408 is utilized. Alternatively, a single scraper contact 404 is utilized and is wide enough to clean more than one, and possibly all, of the emitter wires 408.

Referring to FIG. 7, in accordance with another embodiment of the present invention, an additional rotatable pulley or cleaning wheel 502 is contact with a portion of the emitter wire 508 to clean the wire 508 as the wire 508 moves along the loop. In one embodiment, the cleaning wheel 502 is located adjacent to one or more of the pulleys 510 upon which the emitter wire 508 is disposed. Alternatively, or additionally, the cleaning wheel 506 (shown in phantom in FIG. 7) is placed at any other locations adjacent the wire loop emitter electrode 508.

The outer surface 504 of the cleaning wheel 502 is preferably rough or bristled in one embodiment, so that the cleaning wheel 502 able to clean debris from the electrode 508 as the electrode 508 moves in relation to the wheel 502. Friction between the surfaces of the emitter wire 508 and the cleaning wheel 502 can cause the cleaning wheel 502 to rotate when the emitter wire 508 moves along the loop. Accordingly, there is no need for a separate motor or other mechanism for rotating the cleaning wheel 502, although one can be included. It is also possible that the rotation of the cleaning wheel 502 could be used to cause one of the pulleys 510 to rotate, thereby causing the emitter wire 508 to move along the loop. It should be noted that the cleaning mechanism discussed above are in no way limiting and other mechanisms and devices are contemplated which clean the emitter wire. One possible cleaning mechanism is one or more beads or bead-like mechanisms having a channel which the emitter wire passes through, whereby the emitter wire is cleaned by scraping against the inside walls of the channel when the bead and wire are moved in relation to one another. More details of the bead are discussed in the '417 patent referenced above.

Referring now to FIG. 8, in accordance with another embodiment of the present invention, a brush 602 is located adjacent to and in contact with the emitter wire 608. The brush 602 cleans debris from the emitter electrode 608 as the electrode 608 moves past the brush 602 along the loop 612. The brush 602 includes bristles 604 which extend at least as far as, and possibly past, the electrode 608. The bristles 604 preferably have a high voltage breakdown, have a high dielectric constant, and can withstand high temperature. The brush 602 is preferably attached within the housing 102 so that the bristles 604 extend toward the emitter electrode 608. In FIG. 8, the brush 602 is shown as being located between the upper and lower pulleys 610. It is also possible that the brush 602 is in contact with one or both of the pulleys 610. In another embodiment, the brush 602 is positioned between the emitter electrode wires 608, such that the bristles 604 simultaneously clean the wires 608 on both sides of the loop. Alternatively, a single brush 602 can be made wide enough to clean more than one, and possibly all, of the wire loop electrodes 608 if more than one set of electrode assemblies are present in the housing.

In another embodiment, the pulleys themselves include a frictional surface in contact with the emitter wire such that the frictional surface cleans debris from the emitter wire as the wire is along the loop. For example, one or more of the pulleys include a felt or other soft material along the interior radial surface which cleans the wire when the wire comes into contact with the interior radial surface.

FIG. 9 illustrates an electrical block diagram for driving the system described above, according to embodiments of the present invention. An electrical power cord that plugs into a common electrical wall socket provides a nominal 110VAC. An electromagnetic interference (EMI) filter 810 is placed across the incoming nominal 110VAC line to reduce and/or eliminate high frequencies generated by the various circuits. Batteries are alternatively used to power the systems, as would be clear to one of ordinary skill in the art.

A DC Power Supply 814 is designed to receive the incoming nominal 110VAC and to output a first DC voltage (e.g., 160VDC) for the high voltage generator 140. The first DC voltage (e.g., 160VDC) is also stepped down through a resistor network or transformer to a second DC voltage (e.g., about 12VDC) that is supplied to a micro-controller unit (MCU) 830. The MCU 830 can be, for example, a Motorola 68HC908 series micro-controller. In accordance with an embodiment of the present invention, the MCU 830 monitors the stepped down voltage (e.g., about 12VDC), which is labeled the AC voltage sense signal in FIG. 9, to determine if the AC line voltage is above or below the nominal 110VAC, and to sense changes in the AC line voltage. For example, if a nominal 110VAC increases by 10% to 121VAC, then the stepped down DC voltage will also increase by 10%. The MCU 830 senses this increase and then reduces the pulse width, duty cycle and/or frequency of the low voltage pulses to maintain the output power (provided to the high voltage generator 140) to be the same as when the line voltage is at 10VAC. Conversely, when the line voltage drops, the MCU 830 senses this decrease and appropriately increase the pulse width, duty cycle and/or frequency of the low voltage pulses to maintain a constant output power. Such voltage adjustment features of the present invention also enable the same unit to be used in different countries that have different nominal voltages than in the United States (e.g., in Japan the nominal AC voltage is 100VAC).

The high voltage pulse generator 140 is coupled between the emitter electrode wire 208 and the collector electrode 206 (FIG. 2), to provide a potential difference between the electrodes. The high voltage generator 140 additionally, or alternatively, applies a voltage potential to the driver electrode 132. The high voltage pulse generator 140 maybe implemented in many ways. In the embodiment shown, the high voltage pulse generator 140 includes an electronic switch 826, a step-up transformer 816 and a voltage multiplier 818. The primary side of the step-up transformer 816 receives the first DC voltage (e.g., 160VDC) from the DC power supply. An electronic switch receives low voltage pulses (of perhaps 20 −25 KHz frequency) from the micro-controller unit (MCU) 830. Such a switch is shown as an insulated gate bipolar transistor (IGBT) 826. The IGBT 826, or other appropriate switch, couples the low voltage pulses from the MCU 830 to the input winding of the step-up transformer 816. The secondary winding of the transformer 816 is coupled to the voltage multiplier 818, which outputs high voltages to the emitter and collector electrode arrays 110 and 120. In general, the IGBT 826 operates as an electronic on/off switch. Such a transistor is well known in the art.

When driven, the generator 140 receives the low input DC voltage (e.g., 160VDC) from the DC power supply 814 and the low voltage pulses from the MCU 830, and generates high voltage pulses of preferably at least 5 KV peak-to-peak with a repetition rate of about 20 to 25 KHz. Preferably, the voltage multiplier 818 outputs about 6 to 9 KV to the emitter array 110, and about 12 to 18 KV to the collector array 120. It is within the scope of the present invention for the voltage multiplier 818 to produce greater or smaller voltages. The high voltage pulses preferably have a duty cycle of about 10%-15%, but may have other duty cycles, including a 100% duty cycle.

The MCU 830 receives an indication of whether the control dial 144 is set to the LOW, MEDIUM or HIGH airflow setting. The MCU 830 controls the pulse width, duty cycle and/or frequency of the low voltage pulse signal provided to switch 826 to control the airflow output, based on the setting of the control dial 114. To increase the airflow output, the MCU 830 increases the pulse width, frequency and/or duty cycle. Conversely, to decrease the airflow output rate, the MCU 830 reduces the pulse width, frequency and/or duty cycle. In accordance with an embodiment, the low voltage pulse signal (provided from the MCU 830 to the high voltage generator 140) has a fixed pulse width, frequency and duty cycle for the LOW setting, another fixed pulse width, frequency and duty cycle for the MEDIUM setting, and a further fixed pulse width, frequency and duty cycle for the HIGH setting.

The MCU 830 can also include various timing and maintenance features as described in detail in U.S. application Ser. No. 11/003,671 incorporated by reference herein. The MCU 830 can also detect arcing in various manners as described in detail in U.S. application Ser. No. 10/625,401 incorporated by reference herein.

Many of the above-described features of the present invention also relate to cleaning emitter electrodes of electro-kinetic air transporter and conditioner devices. Collectively, electro-kinetic air transporter and conditioner devices and ESP devices are referred to simply as air conditioning devices, since both types of devices condition the air by electronically cleaning the air and producing ions. More detail regarding electro-kinetic air transporter devices are described in U.S. Application (SHPR-01421US0) incorporated by reference herein.

The foregoing descriptions of the preferred embodiments of the present invention have been provided for the purposes of illustration and description. It is not intended to be exhaustive or to limit the invention to the precise forms disclosed. Many modifications and variations will be apparent to the practitioner skilled in the art. Modifications and variations maybe made to the disclosed embodiments without departing from the subject and spirit of the invention as defined by the following claims. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. An air conditioning system comprising:
a. an emitter wire configured to be movable within a housing, wherein at least a portion of the emitter wire is cleaned when moved; and
b. a collector electrode downstream of the emitter wire in the housing, wherein the collector electrode causes the emitter wire to move when the collector electrode is moved in a desired direction.

2. The system of claim 1 wherein the emitter wire is configured in a loop having at least two pulleys on opposed ends of the loop.

3. The system of claim 1 further comprising a gear mechanism coupled to at least one of the pulleys, the gear mechanism adapted to mesh with a corresponding gear feature of the collector electrode, wherein the gear mechanism rotates the pulley when the collector electrode is moved in a desired direction.

4. The system of claim 1 wherein the emitter wire is configured in a loop and having a first wire portion and a second wire portion, wherein the first wire portion is downstream of the second wire portion.

5. The system of claim 1 wherein the emitter wire is configured in a loop and having a first wire portion and a second wire portion, wherein the first and second wire portions are substantially equidistant upstream of the collector electrode.

6. The system of claim 1 further comprising a cleaning element configured to clean the emitter wire when the emitter wire moves.

7. The system of claim 1 further comprising a cleaning element configured to clean the emitter wire when the emitter wire moves, wherein the cleaning element is a brush.

8. The system of claim 1 further comprising a cleaning element configured to clean the emitter wire when the emitter wire moves, wherein the cleaning element is a scraper.

9. The system of claim 1 further comprising a cleaning element configured to clean the emitter wire when the emitter wire moves, wherein the cleaning element is a rotatable member.

10. An air conditioning system, comprising:
a. an emitter wire configured in a loop;
b. a collector electrode movable in relation to the emitter wire, wherein the emitter wire is moved along the loop when the collector electrode is moved; and
c. a cleaning element in contact with the emitter wire, wherein the cleaning element cleans the emitter wire during movement.

11. The system of claim 10 further comprising at least two pulleys configured on opposed ends of the loop.

12. The system of claim 10 further comprising a gear mechanism coupled to at least one of the pulleys, the gear mechanism adapted to mesh with a corresponding gear feature of the collector electrode, wherein the gear mechanism rotates the pulley when the collector electrode is moved in a desired direction.

13. The system of claim 10 wherein the emitter wire is configured in a loop and having a first wire portion and a second wire portion, wherein the first wire portion is downstream of the second wire portion.

14. The system of claim 10 wherein the emitter wire is configured in a loop and having a first wire portion and a second wire portion, wherein the first and second wire portions are substantially equidistant upstream of the collector electrode.

15. The system of claim 10 wherein the cleaning element is a brush.

16. The system of claim 10 wherein the cleaning element is a scraper.

17. The system of claim 10 wherein the cleaning element is a rotatable member.

18. An air conditioning device comprising: an emitter wire configured to at least emit ions in a flow of air, the emitter wire coupled to a plurality of pulleys and arranged in a loop, wherein at least one of the pulleys is configured to move the wire along the loop to clean the wire when a force is applied thereto.

19. The device of claim 18 further comprising a cleaning element in contact with at least a portion of the emitter wire, the cleaning element configured to clean the emitter wire when moved in relation thereto.

20. The device of claim 18 further comprising a collector electrode downstream of the emitter wire, wherein the collector electrode applies the force to the pulley when moved in a desired direction.
